(19) United States
(12) Patent Application Publication
(10) Pub. No.: US 2025/0124388 A1
(43) Pub. Date: Apr. 17, 2025

(54) METHOD AND SYSTEM FOR CREATING OPTIMAL SUPPLY PLAN

(71) Applicant: SAMSUNG SDS CO., LTD., Seoul (KR)

(72) Inventors: Won Seok CHOI, Seoul (KR); Jeong Ho Park, Seoul (KR)

(73) Assignee: SAMSUNG SDS CO., LTD., Seoul (KR)

(21) Appl. No.: 18/430,188

(22) Filed: Feb. 1, 2024

(30) Foreign Application Priority Data
Oct. 17, 2023 (KR) 10-2023-0138983

(51) Int. Cl. G06Q 10/0637; G06Q 10/087; G06Q 30/0202

(52) U.S. Cl. CPC G06Q 10/06375; G06Q 10/087; G06Q 30/0202

(57) ABSTRACT

A method for creating an optimal supply plan is provided. The method may include creating supply plans for multiple goods demands, creating a plurality of candidate supply plans by modifying at least a part of the supply plans based on priorities and goods resources information of the multiple goods demands, selecting a first candidate supply plan from among the plurality of candidate supply plans based on results of evaluation of the plurality of candidate supply plans, and replacing at least a part of the supply plans with the first candidate supply plan.

### CROSS-REFERENCE TO RELATED APPLICATION

This application claims priority from Korean Patent Application No. 10-2023-0138983 filed on Oct. 17, 2023, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for creating an optimal supply plan, and more particularly, to a method and system for creating an optimal supply plan for multiple demands for goods using a local search technique.

### 2. Description of the Related Art

In supply chain management (SCM), the role of a master planning (MP) solution is to establish an optimal supply plan that may meet customer delivery requirements based on limited supply capabilities such as factory capacity and available materials.

In the conventional field of MP, solutions mainly utilizing an order-by-order (OBO) technique or linear planning (LP) technique have been predominantly used. The OBO technique has the advantage of being able to quickly establish supply plans but falls short in quality due to its inability to solve issues such as the Veggie-Pizza Problem. On the other hand, the LP technique ensures optimal solutions but has the downside of being time-consuming and challenging to incorporate integer constraints such as lot size.

Therefore, there is a demand for a technology that may establish an improved supply plan compared to the OBO technique and, at the same time, accommodate integer constraints difficult for the LP technique, while also being able to quickly develop a high-quality supply plan.

### SUMMARY

Aspects of the present disclosure provide a method and system capable of creating an optimal supply plan that may satisfy multiple goods demands.

Aspects of the present disclosure also provide a method and system capable of creating an improved supply plan in a short time by creating and evaluating numerous candidate supply plans through a local search technique.

Aspects of the present disclosure also provide a method and system capable of effectively utilizing limited goods resources in creating a supply plan for multiple goods demands.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to the aforementioned and other embodiments of the present disclosure, it is possible to quickly and effectively establish an optimal supply plan not by entirely revising a previously created supply plan, but by creating and evaluating multiple candidate supply plans using the LS technique and determining a final supply plan based on the results of the evaluation.

Additionally, multiple candidate supply plans are created in consideration of the priorities of multiple goods demands and resources information for the goods, and one of the multiple candidate supply plans is selected based on the results of the evaluation of the multiple candidate supply plans, thereby creating an optimal supply plan.

Moreover, by retrieving and then reallocating goods resources already assigned to the multiple goods demands, limited goods resources may be used efficiently in the right places.

Furthermore, by establishing an optimized supply plan for the multiple goods demands, user satisfaction and usability may be enhanced.

It should be noted that the effects of the present disclosure are not limited to those described above, and other effects of the present disclosure will be apparent from the following description.

According to an aspect of the inventive concept, there is a method for creating an optimal supply plan performed by at least one processor. The method may include creating supply plans for multiple goods demands, creating a plurality of candidate supply plans by modifying at least a part of the supply plans based on priorities and goods resources information of the multiple goods demands, selecting a first candidate supply plan from among the plurality of candidate supply plans based on results of evaluation of the plurality of candidate supply plans, and replacing at least a part of the supply plans with the first candidate supply plan.

In some embodiments, the goods resources information of a goods demand may include at least one of a production capacity or available materials information of a factory with respect to a corresponding good.

In some embodiments, the creating the plurality of candidate supply plans may include determining a first goods demand with a highest priority based on the priorities of the multiple goods demands; discarding a supply plan for a second goods demand based on a determination that, from analysis of the goods resources information, there is a shortage of goods resources to meet the first goods demand; and creating a candidate supply plan for the first goods demand using goods resources secured from the discarded supply plan.

In some embodiments, determining the first goods demand may include classifying the multiple goods demands into a plurality of groups based on categories of priorities; assigning weights to the plurality of groups based on priorities of the plurality of groups; selecting a first group from among the plurality of groups based on the assigned weights; and selecting the first goods demand from goods demands belonging to the first group.

In some embodiments, the goods resources information may include a goods production capacity of a factory, and the discarding the supply plan for the second goods demand may include, based on a determination that a goods production capacity of a first factory is insufficient for the first goods demand, discarding the supply plan for second goods demand for a second factory.

In some embodiments, the goods resources information may include a goods production capacity of a factory, and the discarding the supply plan for the second goods demand may include, based on a determination that there is a shortage of available materials in a first factory to meet the first goods demand, discarding the supply plan for the second goods demand for a second factory.

In some embodiments, creating the candidate supply plan for the first goods demand may include not altering goods resources already assigned to the multiple goods demands.

In some embodiments, the evaluation of the plurality of candidate supply plans may be based on return-to-forecast (RTF) fulfillment rates calculated for the plurality of candidate supply plans.

In some embodiments, replacing the supply plans with the first candidate supply plan may include calculating scores for the supply plans and the first candidate supply plan and, based on the score for the first candidate supply plan being higher than scores for the at least a part of the supply plans, replacing the at least a part of the supply plans with the first candidate supply plan.

In some embodiments, replacing the supply plans with the first candidate supply plan may include replacing the at least a part of the supply plans with the first candidate supply plan only if the first candidate supply plan has been created by a first local search technique.

In some embodiments, the method may further include repeatedly performing the creating the plurality of candidate supply plans, the selecting the first candidate supply plan, and the replacing the at least a part of the supply plans with the first candidate supply plan, until a preset condition is met.

In some embodiments, the preset condition may be whether an amount of time elapsed since the creating the plurality of candidate supply plans exceeds a reference value.

In some embodiments, the preset condition may be whether a number of iterations of the creating the plurality of candidate supply plans, the selecting the first candidate supply plan, and the replacing the at least a part of the supply plans with the first candidate supply plan exceeds a reference count.

In some embodiments, the preset condition may be whether an RTF fulfillment rate of the first candidate supply plan, before the repeatedly performing, is higher than an RTF fulfillment rate of a second candidate supply plan obtained by repeatedly performing the creating the plurality of candidate supply plans, the selecting the first candidate supply plan, and the replacing the at least a part of the supply plans with the first candidate supply plan.

According to an aspect of the inventive concept, there is a system for creating an optimal supply plan. The system may include a processor, and a memory configured to store instructions, wherein the instructions, when executed by the processor, cause the processor to perform: creating supply plans for multiple goods demands; creating a plurality of candidate supply plans by modifying at least a part of the supply plans based on priorities and goods resources information of the multiple goods demands; selecting a first candidate supply plan from among the plurality of candidate supply plans based on results of evaluation of the plurality of candidate supply plans; and replacing at least a part of the supply plans with the first candidate supply plan.

In some embodiments, the creating the plurality of candidate supply plans may include: determining a first goods demand with a highest priority based on the priorities of the multiple goods demands; discarding, based on a determination that, from analysis of the goods resources information, there is a shortage of goods resources to meet the first goods demand; and creating a candidate supply plan for the first goods demand using goods resources secured from the discarded supply plan.

In some embodiments, the goods resources information may include a goods production capacity of a factory, and the discarding may include: based on a determination that a goods production capacity of a first factory is insufficient for the first goods demand, discarding the supply plan for the second goods demand for a second factory.

In some embodiments, the goods resources information may include a goods production capacity of a factory, and the discarding may include: based on a determination that there is a shortage of available materials in a first factory to meet the first goods demand, discarding the supply plan for the second goods demand for a second factory.

In some embodiments, in the creating the candidate supply plan for the first goods demand, goods resources already assigned to the multiple goods demands may not be altered.

In some embodiments, the evaluation of the plurality of candidate supply plans may be based on return-to-forecast (RTF) fulfillment rates calculated for the plurality of candidate supply plans.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating a method of creating an optimal supply plan using a local search technique according to an embodiment of the present disclosure;

FIG. 2 is a detailed flowchart illustrating some of the operations illustrated in FIG. 1;

FIG. 3 is a detailed flowchart illustrating some of the operations illustrated in FIG. 2;

FIG. 4 is a schematic diagram illustrating some of the operations illustrated in FIG. 3;

FIG. 5 is a detailed flowchart illustrating the step of creating an optimal supply plan using the goods resource information, as performed in the method of FIG. 2;

FIG. 6 is an exemplary diagram illustrating some of the operations illustrated in FIG. 5;

FIG. 7 is an exemplary diagram illustrating some of the operations illustrated in FIG. 5;

FIG. 8 is an exemplary diagram illustrating a method of creating an optimal supply plan according to another embodiment of the present disclosure, which involves repeatedly performing some of the operations illustrated in FIG. 2; and

FIG. 9 is a hardware configuration view of a system for creating an optimal supply plan using a local search technique, according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing the present disclosure, when it is determined that the detailed description of the related well-known configuration or function may obscure the gist of the present disclosure, the detailed description thereof will be omitted.

Unless otherwise defined, terms used in the following embodiments (including technical and scientific terms) may be used in a meaning that may be commonly understood by those of ordinary skill in the art to which the present disclosure belongs, but this may vary depending on the intention of engineers working in the related field, precedents, and the emergence of new technologies. Terminology used in this disclosure is for describing the embodiments and is not intended to limit the scope of the disclosure.

Expressions in the singular number used in the following embodiments include plural concepts unless the context clearly indicates that the singular number is specified. Also, plural expressions include singular concepts unless clearly specified as plural in context.

In addition, terms such as first, second, A, B, (a), and (b) used in the following embodiments are only used to distinguish certain components from other components, and the terms does not limit the nature, sequence, or order of the components.

Before explaining this specification, some terms used in the specification will hereinafter be clarified first.

Supply chain management (SCM) may refer to a comprehensive innovation activity for processes, systems, or organizations that seek to improve customer satisfaction and maximize profits by supplying the right products and services at the right time and place through the entire optimization process, including marketing, sales, service, manufacturing, procurement, logistics, and development, across the entire supply chain from the supplier's supplier to the customer's customer.

Master planning (MP) may refer to a method of establishing an optimal supply plan that may meet customer delivery deadlines and demand based on limited supply capabilities such as the production capacity of a factory and available materials.

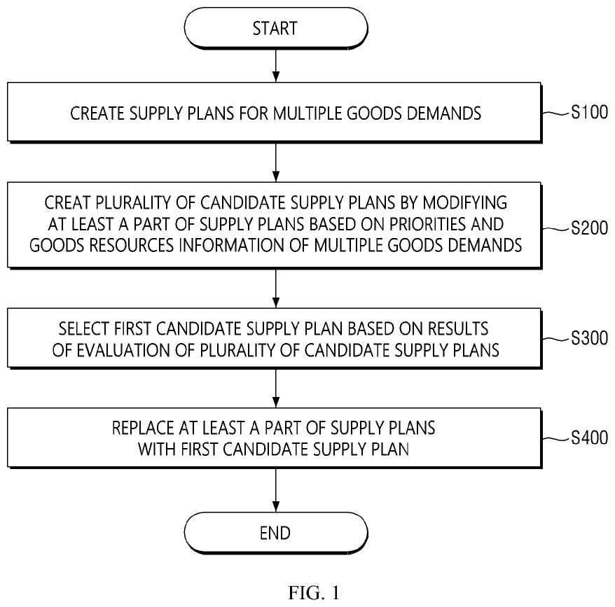

A method of creating an optimal supply plan according to some embodiments of the present disclosure, as will be described with reference to FIGS. 1 through 9, may refer to a method created by a service server in a service environment supporting SCM through MP.

Various embodiments of the present disclosure will hereinafter be described with reference to the attached drawings.

FIG. 1 is a schematic view illustrating a method of creating an optimal supply plan using a local search technique according to an embodiment of the present disclosure. However, the embodiment of FIG. 1 is merely exemplary, and some steps may be added to or deleted from the embodiment of FIG. 1 as necessary. For reference, FIG. 1 illustrates steps/operations of a method of creating an optimal supply plan performed by a first server that produces and manages MP in an SCM system. Therefore, in the following descriptions, if the subject of a particular step/operation is omitted, the particular step/operation may be understood as being performed by the first server.

Referring to FIG. 1, the method of creating an optimal supply plan according to an embodiment of the present disclosure may start with step S100, which involves creating supply plans for multiple goods demands. Here, the supply plans may be initial supply plans created by an order-by-order (OBO) method, which is a type of heuristic technique.

Additionally, the OBO method allows for quick planning, but has limitations in establishing an optimal supply plan, leading to relatively lower qualities of supply contracts. Thus, there is a need for a technology that may modify the initial supply plans created by the OBO method to establish optimal supply plans.

The problems with supply plans created using the conventional OBO method and a method of creating optimal supply plans by modifying the supply plans created by the OBO method, according to an embodiment of the present disclosure, will be described later with reference to FIGS. 2, 6, and 7.

Referring to FIG. 1, in step S200, the first server may create multiple candidate supply plans by modifying the supply plans created in step S100. In the process of creating the multiple candidate supply plans, the priorities and goods resources information of the multiple goods demands may be referenced. Additionally, the goods resources information may include information regarding the goods production capacity of each factory and materials inventory information for the goods in each factory.

For example, the first server may create multiple candidate supply plans by partially modifying some of the supply plans created by matching the multiple goods demands with suppliers (e.g., factories) through the OBO method. Specifically, the first server may select a goods demand with a highest priority from among the multiple goods demands, and create multiple candidate supply plans for the selected goods demand in consideration of the production capacity and materials inventory information of previously assigned goods suppliers (e.g., factories) for the selected goods demand. This will be described later in detail with reference to FIGS. 2 through 7.

In short, the first server may apply the local search technique to an already created supply plan to create multiple candidate supply plans. In this process, the priority and goods resources information of the corresponding goods demand may be referenced.

Therefore, optimal supply plans may be quickly and effectively established by revising not all, but only some of the previously created supply plans, creating and evaluating multiple candidate supply plans, and determining final supply plans based on the results of the evaluation.

Additionally, by creating multiple candidate supply plans in consideration of the priorities of demands for goods and resources information for the goods, the needs of both goods suppliers and demanders may be met, potentially enhancing user satisfaction and usability.

In step S300, the first server may select a first candidate supply plan based on the results of evaluation of the multiple candidate supply plans created in step S200. The evaluation of the multiple candidate supply plans may be performed based on the calculated return-to-forecast (RTF) fulfillment rates of the multiple candidate supply plans. That is, the first server may determine a candidate supply plan with a highest RTF fulfillment rate as an optimal supply plan, i.e., the first candidate supply plan.

Here, RTF fulfillment rate may refer to the quantity fulfilled by an MP plan for the demand for goods. For example, if the demand for goods is 100 and the MP plan fulfills 70, the RTF fulfillment rate of this goods demand may be calculated as 70.

In step S400, the first server may replace at least a part of the supply plans created in step S100 with the first candidate supply plan created in step S300. Specifically, step S400 may involve calculating scores for the created supply plans and the first candidate supply plan, and replacing the created supply plans with the first candidate supply plan only if the calculated score for the first candidate supply plan is higher than the calculated scores of the created supply plans. The score for each candidate supply plan may be calculated using various methods and criteria, and RTF fulfillment rate is commonly used as a general indicator of the quality of each supply plan in practice.

Thus, as the supply plan created by the OBO method is replaced with the first candidate supply plan with a higher RTF fulfillment rate, information regarding multiple goods demands and their corresponding suppliers may be updated, and an optimal supply plan may be created. Consequently, user satisfaction and usability may be effectively enhanced.

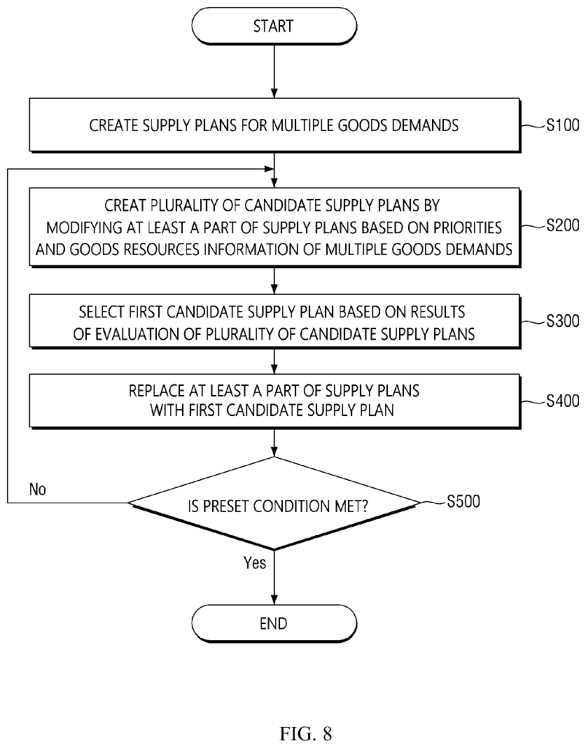

However, steps S100 through S400, which are for creating an optimal supply plan, may be performed as a single continuous process, as illustrated in FIG. 1, but the present disclosure is not limited thereto. Alternatively, steps S200 through S400 may be performed repeatedly at least twice to create an optimal supply plan, and this will be described later with reference to FIG. 8.

In summary, supply plans created by the OBO method are not likely optimal because they do not sufficiently consider the priorities and goods resources information of goods demands. Additionally, a conventional linear planning (LP) method may create more suitable supply plans compared to those created by the OBO method, but may be time-consuming. The LP method, which is one of the optimization techniques, aims to optimize a linear objective function while satisfying given linear conditions. The LP method is commonly used for determining limits of variation when there exists a linear relationship between variable factors and is often employed in problems such as production planning or transportation planning.

Therefore, by using the local search method that partially modifies a previously created supply plan, multiple candidate supply plans may be quickly and effectively created, compared to the OBO and LP methods.

Furthermore, since multiple candidate supply plans are created in consideration of the priorities of the multiple goods demands and the goods resources and one of the created candidate supply plans is selected as an optimal supply plan based on the results of evaluation of the created candidate supply plans, user satisfaction and usability may be enhanced, and the consumption of physical and temporal resources used in the production of the goods and the management of the inventory may be reduced.

The process of creating multiple candidate supply plans by referencing the priorities of multiple demands for goods and resources information for the goods will hereinafter be described in further detail with reference to FIG. 2.

FIG. 2 is a detailed flowchart illustrating some of the operations illustrated in FIG. 1. Specifically, FIG. 2 is an exemplary flowchart illustrating the process of creating multiple candidate supply plans by determining a first goods demand from among the multiple goods demands, discarding a supply plan for a different goods demand from the first goods demand, based on goods resources information, and utilizing goods resources secured from the discarded supply plan. However, the embodiment of FIG. 2 is merely exemplary, and some steps may be added to or deleted from the embodiment of FIG. 2 as necessary.

Referring to FIG. 2, the step of creating, by the first server, multiple candidate supply plans by modifying the supply plan created in step S100, based on the priorities of the multiple goods demands and the goods resources information, i.e., step S200 of FIG. 1, may include step S210, which involves determining, by the first server, a goods demand with a highest priority as the first goods demand, based on the priorities of the multiple goods demands, step S220, which involves discarding, by the first server, a supply plan for a second goods demand, based on the results of analysis of the goods resources information, if the goods resources are insufficient to meet the first goods demand, and step S230, which involves creating, by the first server, a candidate supply plan for the first goods demand using the goods resources secured from the discarded supply plan.

Specifically, the first server may determine a goods demand with a highest priority from among the multiple goods demands as the first goods demand, based on the priorities of the multiple goods demands. Here, the priorities may be determined based on who has requested the production of the goods or based on the quantity of the goods, the speed of production of the goods, or the attributes of the goods. In other words, the priorities may be determined in various manners.

Meanwhile, FIG. 2 illustrates an example where a goods demand with a highest priority is determined as the first goods demand, but the present disclosure is not limited thereto. Alternatively, one of goods demands with priorities exceeding a particular reference level may be selected as the first goods demand. Yet alternatively, the multiple goods demands may be grouped into a plurality of groups, one of the groups may be selected based on the priorities of the groups, and one of the goods demands in the selected group may be randomly selected as the first goods demand.

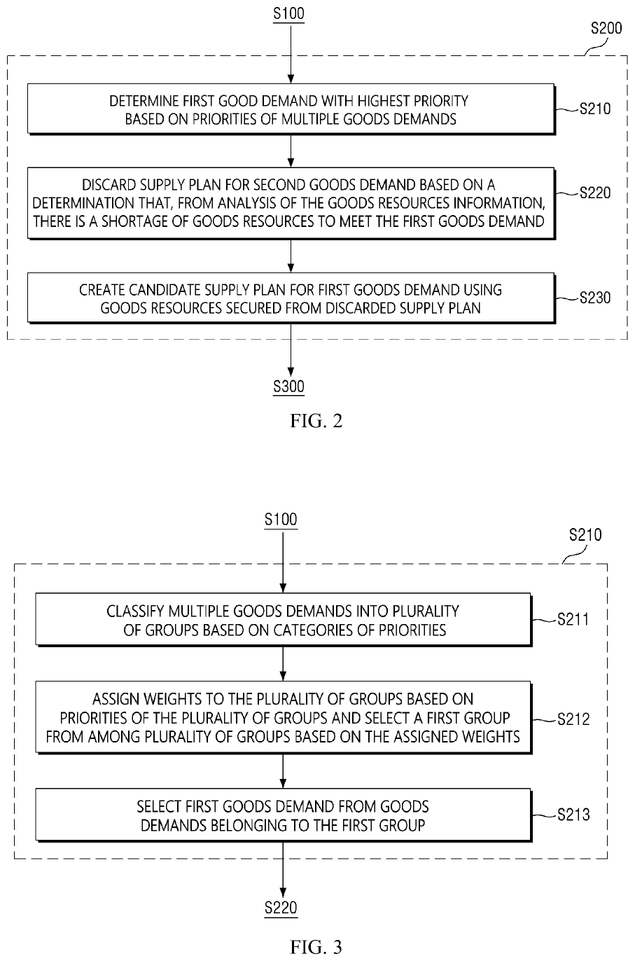

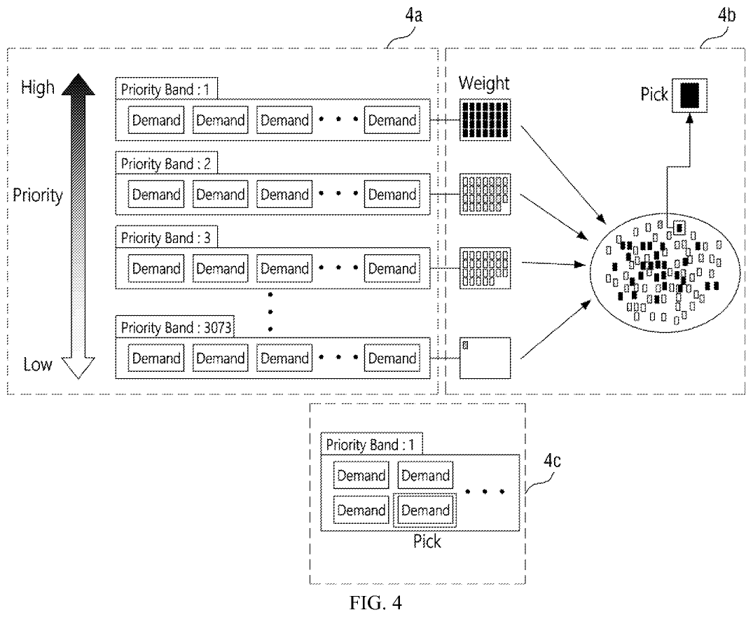

The determining of the first goods demand based on the priorities of the multiple goods demands will be described later in further detail with reference to FIGS. 3 and 4.

Thereafter, if the first server analyzes the goods resource information and determines that there are insufficient goods resources to meet the first goods demand, the first server may retrieve goods resources previously planned for the second goods demand, which is different from the first goods demand. That is, some supply plans previously matched to goods demands may be decarded, thereby securing goods resources for a higher priority goods demand. Various methods may be applied to determine the second goods demand.

In one embodiment, the first server may determine a goods demand with a lower priority than the first goods demand as the second goods demand. In an example embodiment, the second goods demand may be determined in ascending order of priority. In this case, goods resources previously allocated to a lower priority goods demand may be retrieved, and candidate supply plans may be created for the first goods demand by using the retrieved goods resources, leading to the generation of an optimal candidate supply plan and effectively enhancing user satisfaction and usability.

In one embodiment, the first server may determine the second goods demand based on an initial supply plan where initially created goods demands are mapped to their corresponding goods supplies. That is, during the creation of the initial supply plan, a mapping table where a plurality of goods demands and their corresponding goods supplies are mapped may be created, a goods demand adjacent to the first goods demand in the mapping table may be selected as the second goods demand, and a determination may be made as to whether a goods supply corresponding to the second goods demand may meet the first goods demand. Accordingly, a goods demand corresponding to the goods supply resources that may satisfy the first goods demand may be determined as the second goods demand based on the mapping table, thereby reducing the amount of time taken to create candidate supply plans.

Meanwhile, FIG. 2 illustrates an example where a supply plan for a single second goods demand is discarded to meet the insufficient goods resources of the first goods demand, but the present disclosure is not limited thereto. Alternatively, supply plans for multiple goods demands may be discarded to meet the insufficient resources for the first goods demand, and candidate supply plans for the first goods demand may be created using the goods resources secured from the discarded multiple supply plans.

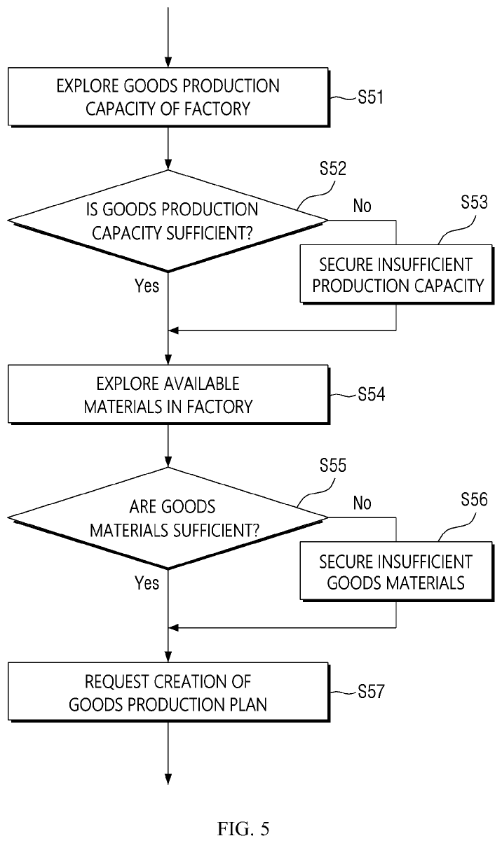

The process of retrieving goods resources by discarding the supply plan for the second goods demand based on the results of analysis of goods resource information will be described later with reference to FIGS. 5 through 7.

Lastly, the first server may create candidate supply plans for the first goods demand using the goods resources (i.e., goods supply resources) secured from the discarded supply plan. In step S230, where the candidate supply plans for the first goods demand are created, unlike in step S200, goods resources corresponding to other goods demands are not retrieved. That is, the first server may create candidate supply plans for the first goods demand only using available goods resources without retrieving other goods resources.

This is because, if the retrieval of goods resources already allocated to other goods demands is allowed in step S230, the goods resources retrieved in step S200 may be retrieved again in step S230, potentially reverting back to step S200.

The step of creating candidate supply plans for the first goods demand using the goods resources retrieved by discarding the supply plan for the second goods demand will be described later with reference to FIGS. 5 through 7.

In summary, by modifying some of the initially created supply plans, candidate supply plans for the goods demand with the highest priority may be created, leading to the generation of an optimal goods supply plan compared to the initial supply plan. Additionally, by retrieving and reallocating goods resources previously allocated to goods demands, the goods resources may be used efficiently in the right places.

Thus, compared to supply plans created by the existing OBO method, optimal candidate supply plans that efficiently allocate limited goods resources may be quickly generated, and user satisfaction and usability may be enhanced.

The step of determining the first goods demand based on the priorities of the multiple goods demands will hereinafter be described with reference to FIGS. 3 and 4.

FIG. 3 is a detailed flowchart illustrating some of the operations illustrated in FIG. 2. However, the embodiment of FIG. 3 is merely exemplary, and some steps may be added to or deleted from the embodiment of FIG. 3 as necessary.

Referring to FIG. 3, step S210, which is a step where the first server determines the first goods demand based on the priorities of the multiple goods demands, may include step S211, which involves categorizing, by the first server, the multiple goods demands into several groups based on the categories of priorities, step S212, which involves assigning, by the first server, weights corresponding to the priorities of the groups and selecting a first group from among the groups in consideration of the assigned weights; and step S213, which involves selecting, by the first server, the first goods demand from among the goods demands belonging to the first group.

First, the first server may categorize the multiple goods demands into a plurality of groups. The plurality of groups may be determined based on predefined categories of priorities. Here, the priorities may be determined based on who has requested the production of the goods or based on the quantity of the goods, the speed of production of the goods, or the attributes of the goods. That is, the categories of the priorities may be determined in various manners.

Thereafter, higher weights may be assigned to groups with higher assigned priorities. That is, a group with a higher assigned weight may be selected from among the plurality of groups. Consequently, groups with higher priorities are more likely to be selected, user satisfaction may be enhanced by creating supply plans for goods demands belonging to groups with higher priorities, and goods resources may be efficiently allocated to meet goods demands. Meanwhile, the weights assigned to the plurality of groups may not necessarily be calculated based on the number of goods demands in each group or the shortage of goods resources for each goods demand.

Finally, one goods demand may be randomly selected from among the goods demands in the selected group. A supply plan that may meet a highest-priority goods demand is not necessarily the most optimal supply plan. Thus, by classifying the multiple goods demands into a plurality of groups based on the predefined priority categories and then randomly selecting one goods demand from one of the plurality of groups, the likelihood of creation of an optimal supply plan may be increased.

FIG. 4 is a schematic diagram illustrating some of the operations illustrated in FIG. 3. Specifically, FIG. 4 is an exemplary diagram illustrating the step of selecting the first goods demand, as performed in the method of FIG. 3.

Referring to box 4a of FIG. 4, the first server may categorize the multiple goods demands into a plurality of groups (e.g., group 1 to group 3073). The multiple goods demands may be grouped based on the categories of priorities that are defined in advance based on information of goods demanders/orderers, the quantity of goods demanded, and the characteristics of the goods.

Thereafter, referring to box 4b of FIG. 4, weights may be assigned to the plurality of groups based on the priorities of the plurality of groups. As explained earlier with reference to FIG. 3, higher weights may be assigned to groups with higher priorities, thereby increasing the likelihood of selection of the groups with higher priorities. For example, box 4b shows that a first-category group with a highest priority has been selected.

Finally, referring to box 4c of FIG. 4, one goods demand may be selected from the first-category group as a first goods demand. The selection of the first goods demand may be performed as follows.

In one embodiment, one of the goods demands belonging to the first-category group may be selected as the first goods demand.

Alternatively, in one embodiment, a goods demand from a particular demander or orderer may be selected from the first-category group as the first goods demand.

Yet alternatively, in one embodiment, a goods demand with a largest goods quantity may be selected from the first category group as the first goods demand.

In short, by determining a goods demand that needs to be met first based on the priorities of the multiple goods demands, the quality of supply plans may be improved, and limited goods resources may be efficiently allocated.

Additionally, for a case where a supply plan that meets the highest-priority goods demand is not an optimal supply plan, the multiple goods demands may be classified into a plurality of groups, and one of the multiple goods demands may be selected according to the weights assigned to the plurality of groups, thereby increasing the likelihood of creation of an optimal supply plan.

The steps of discarding the supply plan for the second goods demand based on the results of analysis of the goods resource information and creating a candidate supply plan based on retrieved goods resources will hereinafter be described with reference to FIGS. 5 through 7.

FIG. 5 is a detailed flowchart illustrating the step of creating an optimal supply plan using the goods resource information, as performed in the method of FIG. 2. However, the embodiment of FIG. 5 is merely exemplary, and some steps may be added to or deleted from the embodiment of FIG. 5 as necessary. Specifically, FIG. 5 illustrates specific operations/steps that may be included in steps S220 and S230 of FIG. 2.

Referring to FIG. 5, after the step of determining the first goods demand based on the priorities of the multiple goods demands, i.e., S210, the step of creating a supply plan for the first goods demand may be performed. To create a supply plan for the first goods demand, the goods resource information (e.g., the production capacity of each factory, available materials in each factory, etc.) may be considered.

First, in step S51, the first server may explore the production capacity of each factory. A target factory to be explored may be a goods supplier or factory already assigned to the first goods demand. In step S52, a determination may be made as to whether the production capacity of the target factory is sufficient. In S53, if the production capacity of the target factory is not sufficient, the necessary production capacity for the first goods demand may be secured. In step S53, goods resources insufficient for the first goods demand may be secured by discarding existing supply plans for other goods demands and retrieving the production capacity of factories assigned to the other goods demands to the first goods demand. That is, the factories assigned to the other goods demands may be reassigned to the first goods demand.

In step S54, if the production capacity of the target factory is sufficient, available materials information of the target factory may be explored. Here, the target factory may be the factory already assigned to the first goods demand or a factory newly assigned to the first goods demand in step S53. Thereafter, in step S55, a determination may be made as to whether the inventory of goods materials in the target factory is sufficient. In step S56, if there is a shortage of goods materials in the target factory, the necessary goods materials for the first goods demand may be secured. Specifically, the necessary goods materials for the first goods demand may be secured by discarding supply plans for other goods demands and reallocating the goods materials inventory of factories assigned to the other goods demands. Thus, the goods materials inventory of the factories assigned to the other goods demands may be used to meet the first goods demand. Finally, in step S57, if sufficient goods materials inventory is secured for the first goods demand, the first server may create a supply plan for the first goods demand in response to a received goods production plan request.

In summary, in the process of creating candidate supply plans for the first goods demand, the goods resource information (e.g., production capacity, goods materials inventory, etc.) may be considered.

If the production capacity of the factory already assigned to the first goods demand is insufficient, a supply plan for the second goods demand in a second factory may be discarded, and the necessary production capacity for meeting the first goods demand may be secured from the discarded plan.

Similarly, if the materials inventory of a first factory assigned to the first goods demand is insufficient, the supply plan for the second goods demand may be discarded, and the necessary goods materials inventory for the first goods demand may be secured from a second factory assigned to the second goods demand.

Therefore, by creating a supply plan for a goods demands after securing necessary goods resources, a goods supply service may be smoothly provided, without any disruption, according to the created supply plan.

Additionally, in the process of securing goods resources, the goods resources of factories assigned to lower-priority goods demands are reallocated to and used for higher-priority demands, ensuring an efficient distribution and effective utilization of limited goods resources.

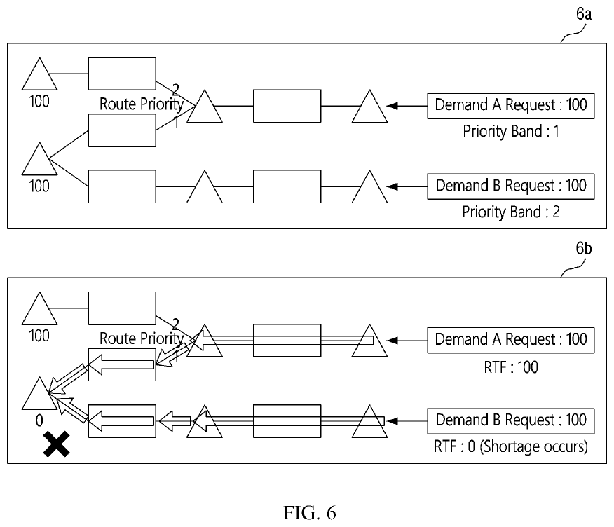

FIG. 6 is an exemplary diagram illustrating some of the operations illustrated in FIG. 5. Specifically, FIG. 6 is an exemplary diagram illustrating the disadvantages of supply plans created using the OBO method and the ideas behind the method of creating an optimal supply plan according to an embodiment of the present disclosure for improvement.

Box 6a of FIG. 6 illustrates a bill of materials (BOM), detailing the type, quantity, and price of materials needed for producing particular goods. That is, FIG. 6 shows visualized information that makes it easy to understand the materials needed for production, the production process, the supply, and the demand of the goods. Here, factories with a supply of 100 may be matched to a goods demand A of 100 and a goods demand B of 100.

Referring to box 6b of FIG. 6, the first server may initially create a supply plan for goods demand A, which has a higher priority than goods demand B, based on the priorities of goods demands A and B. In this case, a supplier (e.g., a factory) for goods demand A may be determined based on the priorities of routes. However, when creating a supply plan for goods demand B with a lower priority, a supplier for goods demand is supposed to be determined according to the routes, but since the supplier for goods demand A is already determined, a situation may arise where goods demand B cannot be met. In other words, according to the OBO method, there may be cases where the RTF fulfillment rate for goods demands becomes zero.

To resolve this problem, the supply plan for goods demand B may be created first, and then the supply plan for goods demand A may be created. However, in reality, it is not feasible to determine the sequence for thousands of goods demands in advance, and constructing a model to determine such sequence is challenging. Thus, there is a limit in defining a supply plan for each goods demand in advance. Therefore, a technique is required to modify some of the already created supply plans for multiple goods demands, allowing for the retrieval and redistribution of goods supply resources allocated to each goods demand.

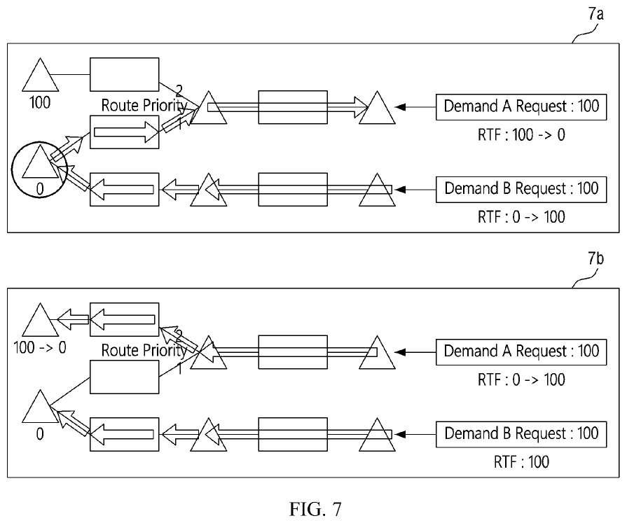

The process of creating an improved supply plan by retrieving and redistributing goods supply resources already allocated to multiple goods demands will hereinafter be described with reference to FIG. 7.

FIG. 7 is an exemplary diagram illustrating some of the operations illustrated in FIG. 5. Specifically, FIG. 7 is an exemplary diagram illustrating the process of discarding an existing supply plan for a goods demand to retrieve goods resources and creating a supply plan using the retrieved goods resources.

Referring to box 7a of FIG. 7, to address the inability to satisfy goods demand B, the first server may secure necessary supply resources for goods demand B, utilizing corresponding route information. Here, the secured supply resources may refer to the goods resources previously assigned to goods demand A, included in the supply plan for goods demand A. That is, if there is a shortage of goods resources to meet goods demand B, the first server may retrieve the goods resources initially reserved for goods demand A and create a supply plan for meeting goods demand B, while traversing the route illustrated in FIG. 7 in reverse.

Thereafter, following the discarding of the existing supply plan for goods demand A, the previously allocated goods resources for goods demand A may be retrieved, and a new supply plan for goods demand A may be created. As explained earlier with reference to FIG. 2, the new supply plan for the A goods demand may be created based on available goods resources without disturbing the goods resources already assigned to other goods demands.

Therefore, referring to box 7b of FIG. 7, an optimal candidate supply plan that may meet multiple goods demands may be created. Although FIG. 7 illustrates the process of creating candidate supply plans for two goods demands, it should not be misconstrued that the supply plans for multiple goods demands are entirely changed. Rather, as discussed with reference to FIGS. 1 through 5, it should be understood that not all the existing supply plans for thousands of goods demands are entirely revised.

The method of creating an optimal supply plan according to an embodiment of the present disclosure allows for the creation of a plurality of candidate supply plans by selectively modifying existing supply plans using the local search technique. Consequently, a single optimal supply plan may be derived through the evaluation of the plurality of candidate supply plans. Therefore, multiple candidate supply plans may be created at the same time by creating new supply plans through the recalculation of the goods resources status for changed supply plans, rather than through the revision of all the existing supply plans, enabling the creation of a more optimal supply plan.

Additionally, to meet goods demand B, a candidate supply plan for goods demand A may be created by discarding the existing supply plan for goods demand A and reallocating the retrieved goods resources from the discarded supply plan to goods demand B. FIG. 7 illustrates the process of creating candidate supply plans for two goods demands, but it should not be misunderstood that only one candidate supply plan is created. In a situation where there are thousands of goods demands, numerous existing supply plans may be discarded to retrieve already-assigned goods resources, and multiple candidate supply plans may be created accordingly.

FIG. 8 is an exemplary diagram illustrating a method of creating an optimal supply plan according to another embodiment of the present disclosure, which involves repeatedly performing some of the operations illustrated in FIG. 2. However, the embodiment of FIG. 8 is merely exemplary, and some steps may be added to or deleted from the embodiment of FIG. 8 as necessary.

The embodiment of FIG. 8 includes the same steps/operations as those illustrated in FIG. 2, and thus, detailed descriptions of any redundant content will be omitted. The embodiment of FIG. 8 will hereinafter be described, focusing on differences from the embodiment of FIG. 2.

Referring to FIG. 8, the method of creating an optimal supply plan according to another embodiment of the present disclosure may include step S500, which involves determining whether a preset condition is met, after performing steps S100, S200, S300, and S400 of FIG. 2.

In step S500, after replacing an existing supply plan with a first candidate supply plan in step S400, a determination may be made as to whether the preset condition is met. Thereafter, steps S200, S300, and S400 may be additionally performed depending on the results of the determination.

That is, the steps of creating a plurality of candidate supply plans in consideration of the priorities and goods resources information of multiple goods demands, selecting a first candidate supply plan from among the plurality of candidate supply plans based on the results of evaluation of the plurality of candidate supply plans, and replacing the existing supply plan with the first candidate plan may be performed repetitively until the preset condition is met.

In one embodiment, the preset condition may be whether the amount of time elapsed since the beginning of the creation of multiple candidate supply plans exceeds a reference value. In this case, if it is determined that the amount of time elapsed since the beginning of the creation of the multiple candidate supply plans exceeds the reference value, the repetition of steps S200, S300, and S400 may be terminated, and the last created first candidate supply plan may be determined as a final supply plan.

In one embodiment, the preset condition may be whether the number of iterations of steps S200, S300, and S400 exceeds a reference count. In this case, if it is determined that the number of iterations of steps S200, S300, and S400 exceeds the reference count, the repetition of steps S200, S300, and S400 may be terminated, and the last created first candidate supply plan may be determined as the final supply plan.

In one embodiment, the preset condition may be whether the RTF fulfillment rate of a first candidate supply plan obtained before the repetition of steps S200, S300, and S400 is greater than the RTF fulfillment rate of a second candidate supply plan obtained through the repetition of steps S200, S300, and S400. In this case, if it is determined that the RTF fulfillment rate of the second candidate supply plan is less than the RTF fulfillment rate of the first candidate supply plan, it may be determined that a further improved supply plan is not plausible. Consequently, the repetition of steps S200, S300, and S400 may be terminated, and the last created first candidate supply plan may be determined as the final supply plan.

To summarize, a more optimal supply plan may be created by repetitively performing the process of creating candidate supply plans by modifying existing supply plans until the preset condition is met.

The methods of creating an optimal supply plan according to some embodiments of the present disclosure have been described so far with reference to FIGS. 1 through 8. According to these embodiments of the present disclosure, a plurality of candidate supply plans may be created not by revising all the existing supply plans but by changing only some of the existing supply plans, and a final supply plan may be determined based on the results of evaluation of the candidate supply plans, leading to quick and effective establishment of an optimal supply plan.

Moreover, an optimal supply plan may be created by creating multiple candidate supply plans in consideration of the priorities and goods resources information of multiple goods demands, and selecting one of the multiple candidate plans based on the results of evaluation of the candidate supply plans. Accordingly, user satisfaction and usability may be enhanced, and physical and temporal resources for use in goods production or inventory management may be conserved.

Furthermore, in the process of securing goods resources, the goods resources from factories assigned to lower-priority goods demands are retrieved and utilized for higher-priority goods demands, ensuring an effective distribution and utilization of limited goods resources.

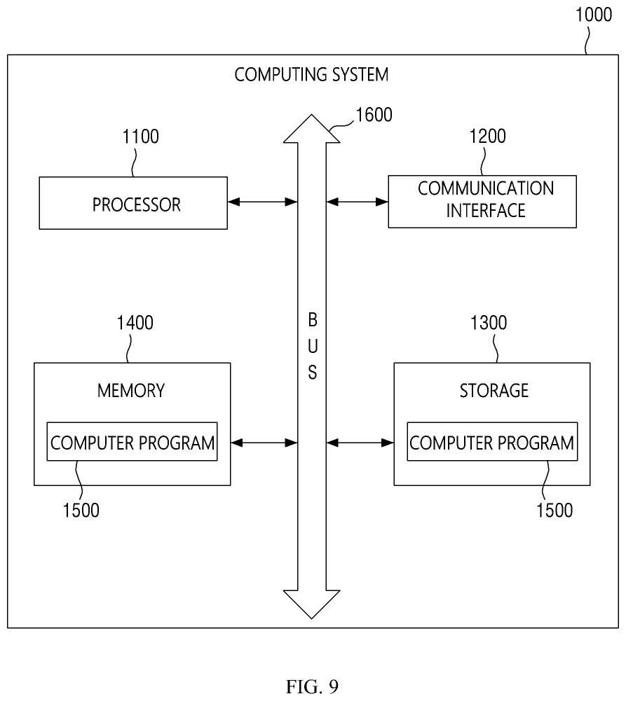

FIG. 9 is a hardware configuration view of a system for creating an optimal supply plan using the local search technique, according to some embodiments of the present disclosure. Referring to FIG. 9, the system 1000 may include at least one processor 1100, a system bus 1600, a communication interface 1200, a memory 1400, which is for loading a computer program 1500 executed by the processor 1100, and a storage 1300, which stores the computer program 1500.

The processor 1100 controls the overall operation of each component of the system 1000. The processor 1100 may perform calculations for at least one application or program to execute methods/operations according to various embodiments of the present disclosure. The memory 1400 stores various data, commands, and/or information. The memory 1400 may load at least one computer program 1500 from the storage 1300 to execute the methods/operations according to various embodiments of the present disclosure. The system bus 1600 provides communication functionality between the components of the system 1000. The communication interface 1200 supports Internet communication for the system 1000. The storage 1300 may non-temporarily store the computer program 1500. The computer program 1500 may include one or more instructions for implementing the methods/operations according to various embodiments of the present disclosure. When the computer program 1500 is loaded into the memory 1400, the processor 1100 may perform the methods/operations according to various embodiments of the present disclosure by executing the instructions.

In some embodiments, the system 1000 may be configured using one or more physical servers included in a server farm based on cloud technologies such as virtual machines. In this case, at least some of the components of the system 1000, such as the processor 1100, the memory 1400, and the storage 1300, may be virtual hardware, and the communication interface 1200 may also be configured as a virtualized networking element such as a virtual switch.

Embodiments of the present disclosure have been described above with reference to FIGS. 1 through 10, but it should be noted that the effects of the present disclosure are not limited to those described above, and other effects of the present disclosure should be apparent from the following description.

The technical features of the present disclosure described so far may be embodied as computer readable codes on a computer readable medium. The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

The protection scope of the present invention should be interpreted by the following claims, and all technical ideas within the equivalent range should be interpreted as being included in the scope of the technical ideas defined by the present disclosure.

What is claimed is:

1. A method of creating an optimal supply plan, performed by at least one processor, the method comprising:
creating supply plans for multiple goods demands;
creating a plurality of candidate supply plans by modifying at least a part of the supply plans based on priorities and goods resources information of the multiple goods demands;
selecting a first candidate supply plan from among the plurality of candidate supply plans based on results of evaluation of the plurality of candidate supply plans; and
replacing at least a part of the supply plans with the first candidate supply plan.

2. The method of claim 1, wherein the goods resources information of a goods demand includes at least one of a production capacity or available materials information of a factory with respect to a corresponding good.

3. The method of claim 1, wherein the creating the plurality of candidate supply plans comprises:
determining a first goods demand with a highest priority based on the priorities of the multiple goods demands;
discarding a supply plan for a second goods demand based on a determination that, from analysis of the goods resources information, there is a shortage of goods resources to meet the first goods demand; and
creating a candidate supply plan for the first goods demand using goods resources secured from the discarded supply plan.

4. The method of claim 3, wherein the determining the first goods demand comprises:
classifying the multiple goods demands into a plurality of groups based on categories of priorities;
assigning weights to the plurality of groups based on priorities of the plurality of groups;
selecting a first group from among the plurality of groups based on the assigned weights; and
selecting the first goods demand from goods demands belonging to the first group.

5. The method of claim 3, wherein
the goods resources information includes a goods production capacity of a factory, and
the discarding comprises, based on a determination that a goods production capacity of a first factory is insufficient for the first goods demand, discarding the supply plan for the second goods demand for a second factory.

6. The method of claim 3, wherein
the goods resources information includes a goods production capacity of a factory, and
the discarding comprises, based on a determination that there is a shortage of available materials in a first factory to meet the first goods demand, discarding the supply plan for the second goods demand for a second factory.

7. The method of claim 3, wherein the creating the candidate supply plan for the first goods demand comprises:
not altering goods resources already assigned to the multiple goods demands.

8. The method of claim 3, wherein the evaluation of the plurality of candidate supply plans is based on return-to-forecast (RTF) fulfillment rates calculated for the plurality of candidate supply plans.

9. The method of claim 1, wherein the replacing comprises calculating scores for the supply plans and the first candidate supply plan and, based on the score for the first candidate supply plan being higher than scores for the at least a part of the supply plans, replacing the at least a part of the supply plans with the first candidate supply plan.

10. The method of claim 1, wherein the replacing comprises replacing the at least a part of the supply plans with the first candidate supply plan only if the first candidate supply plan has been created by a first local search technique.

11. The method of claim 1, further comprising:
repeatedly performing the creating the plurality of candidate supply plans, the selecting the first candidate supply plan, and the replacing the at least a part of the supply plans with the first candidate supply plan, until a preset condition is met.

12. The method of claim 11, wherein the preset condition is whether an amount of time elapsed since the creating the plurality of candidate supply plans exceeds a reference value.

13. The method of claim 11, wherein the preset condition is whether a number of iterations of the creating the plurality of candidate supply plans, the selecting the first candidate supply plan, and the replacing the at least a part of the supply plans with the first candidate supply plan exceeds a reference count.

14. The method of claim 11, wherein the preset condition is whether an RTF fulfillment rate of the first candidate supply plan, before the repeatedly performing, is higher than an RTF fulfillment rate of a second candidate supply plan obtained by repeatedly performing the creating the plurality of candidate supply plans, the selecting the first candidate supply plan, and the replacing the at least a part of the supply plans with the first candidate supply plan.

15. A system for creating an optimal supply plan, comprising:
a processor; and
a memory configured to store instructions,
wherein the instructions, when executed by the processor, cause the processor to perform: creating supply plans for multiple goods demands; creating a plurality of candidate supply plans by modifying at least a part of the supply plans based on priorities and goods resources information of the multiple goods demands; selecting a first candidate supply plan from among the plurality of candidate supply plans based on results of evaluation of the plurality of candidate supply plans; and replacing at least a part of the supply plans with the first candidate supply plan.

16. The system of claim 15, wherein the creating the plurality of candidate supply plans comprises: determining a first goods demand with a highest priority based on the priorities of the multiple goods demands; discarding, based on a determination that, from analysis of the goods resources information, there is a shortage of goods resources to meet the first goods demand; and creating a candidate supply plan for the first goods demand using goods resources secured from the discarded supply plan.

17. The system of claim 16, wherein
the goods resources information includes a goods production capacity of a factory, and
the discarding comprises, based on a determination that a goods production capacity of a first factory is insufficient for the first goods demand, discarding the supply plan for the second goods demand for a second factory.

18. The system of claim 16, wherein
the goods resources information includes a goods production capacity of a factory, and
the discarding comprises, based on a determination that there is a shortage of available materials in a first factory to meet the first goods demand, discarding the supply plan for the second goods for a second factory.

19. The system of claim 16, wherein in the creating the candidate supply plan for the first goods demand, goods resources already assigned to the multiple goods demands are not altered.

20. The system of claim 16, wherein the evaluation of the plurality of candidate supply plans is based on return-to-forecast (RTF) fulfillment rates calculated for the plurality of candidate supply plans.
